(19) United States
(12) Patent Application Publication
(10) Pub. No.: US 2023/0104026 A1
(43) Pub. Date: Apr. 6, 2023

(54) PROACTIVE REFRESH OF ENTITLEMENTS ON VIDEO PLATFORM CLIENTS

(71) Applicant: Charter Communications Operating, LLC, St. Louis, MO (US)

(72) Inventor: Pushpa Sekhara Reddy Matli, Parker, CO (US)

(73) Assignee: Charter Communications Operating, LLC, St. Louis, MO (US)

(21) Appl. No.: 17/492,269

(22) Filed: Oct. 1, 2021

(51) Int. Cl. H04N 21/266; H04N 21/239; H04N 21/258; H04N 21/482; H04N 21/4623

(52) U.S. Cl. CPC H04N 21/26606; H04N 21/2393; H04N 21/25875; H04N 21/4821; H04N 21/4623

(57) ABSTRACT

A method of managing entitlements to program content of a content delivery system is disclosed comprising receiving a request, from a user, by a processing device, to subscribe to a video package or to purchase a video program from the content delivery system. The user has at least one user device configured for watching the program content. At least one entitlement resulting from the subscription or purchase is calculated and connection information for each of the plurality of user devices is retrieved from database. The at least one calculated entitlement is pushed to each user device by the processing device, via a network, using the connection information. A system configured to implement the method and a video streaming device, such as a set-top box and a smart device, for example, are also disclosed. The smart device may be a smart phone or tablet, for example.

### FIELD OF THE INVENTION

Entitlement management across a plurality of user devices and, more particularly, proactively refreshing entitlements across active user devices after subscription changes and program purchases.

### BACKGROUND OF THE INVENTION

Subscription-based content distribution systems provide program content to users on their user devices, such as a set-top box coupled to a television (“TV”) or a smart device, such as smartphones and tablets, for example, which have integral display screens. Users may purchase respective subscription packages that entitle the subscriber to a predetermined grouping of channels and services. Subscription packages may include various combinations or bundles of some of the available channels and services, or for all of the available channels and services provided by the content delivery system. Services may include on-demand services and pay-per-view services, for example. Each package has a respective cost.

Program content is provided to user devices in program signal streams. User devices tune to selected channels to receive program content associated with that channel. To ensure that program content can only be viewed by paying subscribers, the program signal streams are typically scrambled. Decryption keys for descrambling respective program signal streams or programs are provided to set-top boxes and smart devices of user's entitled to view such program content when a user device is turned on and rebooted.

A listing of program content provided by a content delivery system, including the broadcast time and channel, is typically displayable by a user device on an electronic program guide. FIG. 1A is an example of a portion of an electronic program guide 10 showing several hours (2:00 PM-4:00 PM) of programming for CNN on channel 25, CNBC on channel 26, ESPN on channel 27, and HBO on channel 28. The program sources CNN, CNBC, ESPN, and HBO corresponding channels 25, 26, 27, and 28, respectively, are merely exemplary and program content from each of these program sources may be displayed on different channels in different geographic areas.

In some electronic program guides, such as the program guide 10 in FIG. 1A, an icon 12 may be provided on channels that the subscriber is not entitled to view, indicating that the channel is locked. The icon 12 may be a key, a lock, another symbol indicating that the channel is unavailable, or the word “LOCKED”, for example, as shown in FIG. 1A, or a similar word. In this example, CNN and CNBC are part of a package a subscriber subscribes to and are available for viewing while ESPN and HBO are not. In other electronic program guides that do not include an icon 12 or the equivalent, a user may have an option to view all channels provided by the content delivery system or only those channels that the user has subscribed too. In either case, channels and programs that a user is not subscriber to or has not paid for will be locked by the EPG. A user may not then be able to view those channels or programs.

FIG. 1B is an example of an on demand page 14 of user interface that would be displayed on a TV or display of a smart device some of the TV programs and movies that may be available on demand. In this example, each program has an icon 12 indicating that the program is locked, except for “Mom”. This indicates that “Mom” has been previously reserved for viewing. As above, the icon 12 may be a key, a lock, another symbol indicating that the channel is unavailable, or the word “LOCKED” or a similar word, for example, as shown in FIG. 1B. One or more pay-per-view page may be similarly provided to display programs, movies, etc., available for pay-per-view viewing.

If a locked channel or program is selected for viewing, a popup may appear on the user's TV to the effect that the subscriber is not authorized to watch the channel but could upgrade their subscription by calling a phone number of a customer service representative, or via their set-top box or smart device, for example.

In known content delivery systems, when a user updates their subscription and/or purchases a program via their set-top box, a cloud service or other component of the system obtains a list of the user's set-top boxes and their connection information and pushes the updated entitlements to the user's set-top boxes. The pushed entitlements will be received by the user's active set-top boxes so that channels in the updated subscription and/or purchased programs may be viewed on TVs connected to any of those active set-top boxes. The updated entitlements are provided to all the set-top boxes, including the set-top boxes that were off when the purchase was made, when a respective set-top box is turned on and rebooted

The content delivery system instructs the respective user device on which the purchase was made to remove the locked icon on the EPG displayed by the respective user device and a provides a key for the purchased channel(s) or program to the respective user device. This may be accomplished in real-time or near real-time. Referring to FIG. 1A, if a subscriber upgrades their subscription to include ESPN and HBO, for example, the content delivery system would instruct the respective user device to remove the lock icon 12 on the electronic program guide 10 displayable on the respective user device and would send one or more keys to enable descrambling of the program content received on ESPN and HBO the respective user device. This is true for the purchase of individual programs, as well.

### SUMMARY OF THE INVENTION

The right to view program content on a channel and the right to view an individual program is referred herein as an “entitlement”. When a user has an entitlement to a channel or program, it will be indicated on the EPG or other user interfaces on their user device, such as on an on demand or pay-per-view page, and they will be able to view the channel and/or program with their user device.

While a user may be able to watch a channel in the purchased subscription or a purchased program on the set-top box through which the user made the purchase of the new subscription or program, and other active set-top boxes, known content delivery systems do not enable a user to also watch the purchased channels or programs on active smart devices, such as smart phones and tablets, for example, until those smart devices are turned off, turned on, and rebooted. In addition, known content delivery systems do not enable updated subscriptions and/or programs purchased on a first smart device to be viewed on that smart device or other active smart devices. For example, if a user purchases a new subscription on a smart device while a set-top box connected to a TV is also active, the user will not be able to watch any of the channels in the newly purchased subscription on the set-top box because the set top box has not been updated with the current entitlements. The set-top box would need to be turned off, turned on, and rebooted before it is updated with the current subscriptions and/or purchases. Similarly, active user devices will not be updated to reflect a new purchase when the purchase is made through a customer service representative until the user device is turned off, turned on, and rebooted. These issues may negatively impact a customers' experience as they cannot enjoy the services that they have purchased via the desired user device, which can be annoying.

In accordance with embodiments of the invention, all active user devices are updated to reflect current purchases made on any one of the user devices or through a customer service representative. In one example, purchases made on set-top boxes are reflected on active smart devices, purchases made on smart devices are reflected on active smart devices and active set-top boxes, and purchases made on set-top boxes are reflected on active set-top boxes and active smart devices.

In one example, all the active user devices may be updated in in near-real time, without turning off, turning on, and rebooting the active user device. In examples of embodiments of the invention, near-real time may be from one second to a few seconds, such as up to 3 to 5 seconds, up to about a minute, such as 30 seconds or 60 seconds, for example, depending on the capabilities of the network.

In accordance with an embodiment of the invention, a method of managing entitlements to program content of a content delivery system is disclosed comprising receiving a request, from a user, by a processing device, to subscribe to a video package or to purchase a video program from the content delivery system. The user has at least one user device configured for watching the program content. At least one entitlement resulting from the subscription or purchase is calculated and connection information for each at least one user device is retrieved from database. The at least one calculated entitlement is pushed to each at least one user device by the processing device, via a network, using the connection information.

The request may be received from a respective set-top box, a respective smart device, or via a customer care representative, for example. Calculating entitlements may comprise identifying codes corresponding to the subscription or purchase and identifying respective channels in the subscription or a channel on which the purchased program is provided based, at least in part, on a mapping of codes to channels for a geographic location of the user. Pushing at least one entitlement may comprise pushing at least one instruction to each at least one user device to update a user interface displayable by the user device to reflect that the user is entitled to a respective channel and/or program. The at least one instruction may comprise an instruction to remove an icon associated with the respective channel and/or program indicative of the respective channel and/or program being prevented from viewing by the user. Program content may be provided to each at least one user device in a scrambled format and the method may further comprise pushing at least one key to each at least one user device to descramble received program content in the subscription or to descramble the program. The method may comprise receiving the request from a set-top box and pushing the at least one entitlement to all set-top boxes of the user and to all smart devices of the user; receiving the request from a smart device and pushing the entitlements to all set-top boxes of the user and to all smart devices of the user; or receiving the request via a customer service representative and pushing the at least one entitlement to all set-top boxes of the user and/or to all smart devices of the user.

In accordance with another embodiment of the invention, a system for managing entitlements to content of a content delivery system is disclosed comprising at least one database for storing mappings between video packages provided by the content delivery system and respective channels for receiving the programs in the video packages; mappings between individual programs and respective channels for receiving the individual programs, based, at least in part, on a geographic location of a user; and connection information for user devices of respective users. The system further comprises a processing device configured to receive a request, from a user, to subscribe to a video package or to purchase a program from the content delivery system, where the user has at least one user device on which to watch the programs. The processing device is further configured to calculate at least one entitlement resulting from the subscription or purchase, based, at least in part, on the mappings in the at least one database, and obtain connection information for each at least one user device of the user from the at least one database. The processing device is further configured to push the at least one entitlement to the at least one user devices of the user, via a network, using the connection information. The processing device may be configured to implement other features as described above and herein.

In accordance with another embodiment of the invention, a video streaming device is disclosed comprising storage for storing a video streaming platform client and a graphical user interface including an electronic program guide. The video streaming device further comprises a processing device configured to receive entitlements pushed by a content delivery system while active, via a network; update the graphical user interface to indicate that a user is entitled to view respective channels and/or programs, based, at least in part, on the received entitlement; and display the updated graphical user interface. The video streaming device may be a set-top box or a smart device, for example. The smart device may be a smart phone or a table, for example.

The processing device may be configured to update the graphical user interface by removing an icon associated with the respective channel and/or program indicative of the respective channel and/or program being locked from viewing by the user. The at least one processing device may be configured to receive program content from the content delivery system and cause display of the received program content that the user has received an entitlement to, on a display device associated with the video streaming device. The received program content may be scrambled, and the processing device may be configured to receive at least one key for descrambling scrambled program content from the content delivery system, via a network; descramble the scrambled program content using the at least one key; and cause display of the descrambled program content. While the term set-top box is used in the description, it should be understood that the term “set-top box” also refers to set-top terminals.

### BRIEF DESCRIPTION OF THE FIGURES

FIG. 1A is an example of a program guide including icons indicating that certain channels are locked;

FIG. 1B is an example of an on demand page of a user interface including icons indicating that programs are locked;

FIG. 2A is a block diagram of an example of a content delivery system, such as a cable television system, for example, in which embodiments of the invention may be implemented;

FIG. 2B is a block diagram of an example of a system for proactively refreshing entitlements for clients, in accordance with an embodiment of the invention;

FIG. 3 is a more detailed block diagram of the backend of the system of FIG. 2B, in accordance with an embodiment of the invention;

FIG. 4A—FIG. 4B are flow diagrams of examples of portions of a boot up sequence during which client devices are provided with current entitlements to subscriptions and programs, in accordance with an embodiment of the invention;

FIG. 5 is a flow diagram of an example of a method of obtaining offers, in accordance with an embodiment of the invention;

FIG. 6A-FIG. 6D are portions of a flow diagram of an example of a portion a method of pushing entitlements to purchased subscriptions or program to all active devices of a user, in accordance with an embodiment of the invention;

FIG. 6E-FIG. 6F are flow diagrams of examples of methods of keys being provided to set-top boxes and smart devices to descramble scrambled program content, respectively, after entitlements are pushed set-top boxes and smart devices in accordance with embodiments of the invention;

FIG. 7 is a block diagram of an example of a hardware platform configured to perform the processes described above with respect to the backend of FIG. 3; and

FIG. 8 is a block diagram of a user device that may be used in embodiments of the invention.

### DESCRIPTION OF PREFERRED EMBODIMENTS

As discussed above, purchases of new subscriptions with and programs from a content delivery system made via a respective set-top box and/or smart phone, or a customer service representative, may not be reflected on all of a customer's active platforms and devices in real time or near real-time. A user may not, therefore, be able to access the channels of the recently purchased subscription or the recently purchased programs.

As used herein, the term “entitlement” refers to an ability to view a program or program content on a one or more channels based on a purchase of the program or purchase of a subscription that includes the one or more channels. A user may watch programs and program content to which they have entitlements on their user devices, such as set-top boxes coupled to display devices, such as TVs, and on their smart devices. In accordance with embodiments of the invention, after a purchase is made on a user device, such as a user's smart device, other active user devices, including a set-top box that is also active, will also be updated with the purchased entitlement(s). In some content delivery systems, a program or channel to which a user is not entitled may be indicated by a “lock icon” on an electronic program guide (“EPG”) or other such graphical user interface. In this case, in accordance with embodiments of the invention, when an entitlement is received to a locked channel or program, the channel or program is “unlocked,” which includes removal of the lock icon on the EPG. Alternatively, an EPG or other such graphical user interface may only display programs and channels to which a user is entitled or provide such an option to the user. This indicates to the user that a program or channel is available for viewing. In this case, in accordance with embodiments of the invention, the EPG or other such graphical user interface is modified to indicate the availability of the program or channel. In both cases, it is not necessary for the user to reboot their set-top box or IP video App by turning their set-top box off and on again, or by turning the IP video App off and on again on their smart device, to watch a purchased channel or program.

In one example, each new subscription package or program purchase through any available platform (via a user device or a customer service representative, for example) is provided to a common component of the backend of a content delivery system, such as to a billing system of the backend of the content delivery system. Changes in subscriptions and purchases in the customer account are detected, new entitlements are calculated based on the updated subscription and purchases, connection information for all of the user's devices are identified, and the entitlements are pushed to all the user devices based on the connection information. All the user's active devices can receive the pushed entitlements so that the user can watch the channels in the purchased subscription or the purchased program on any of the active devices, without having to turn the active devices off and on again. If the pushed notification is not confirmed by a user device, the backend retries pushing of the entitlements. Retries may be limited to a predetermined number of times. In one example, all a persistent connection is made with each active user device with a push notification service of the backend across a network. Web sockets or Server-sent events may be sent across the Internet or another such network to create the persistent connection. It is noted that other types of video streaming devices may interact with and obtain program content from the content delivery system, such as Roku and Apple TV streaming video devices, for example. In one example, any video streaming device that supports Web sockets or Server-sent events for creating persistent connections with a content delivery system may be used. A streaming media device may be configured to support Web sockets or Server-sent events by downloading an application (“App”) of the content delivery service, for example.

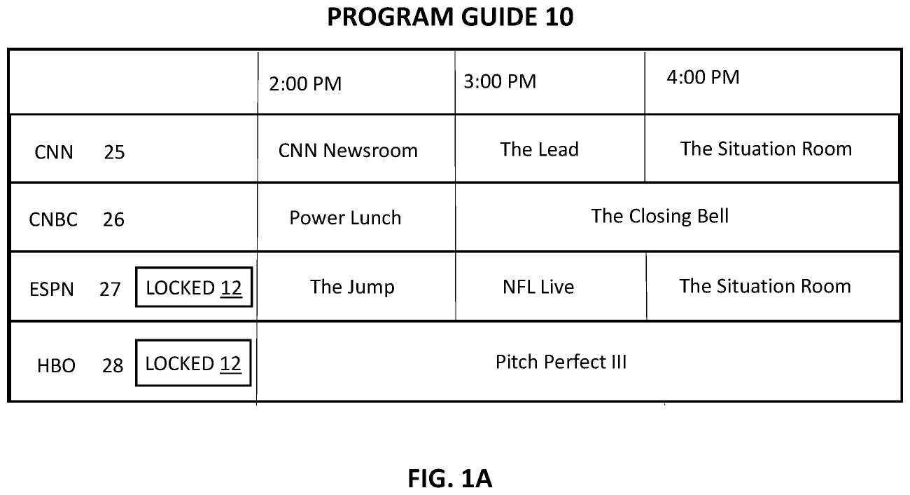

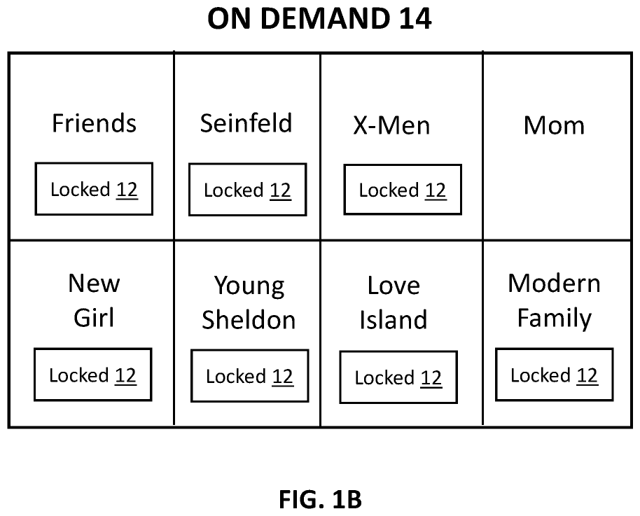

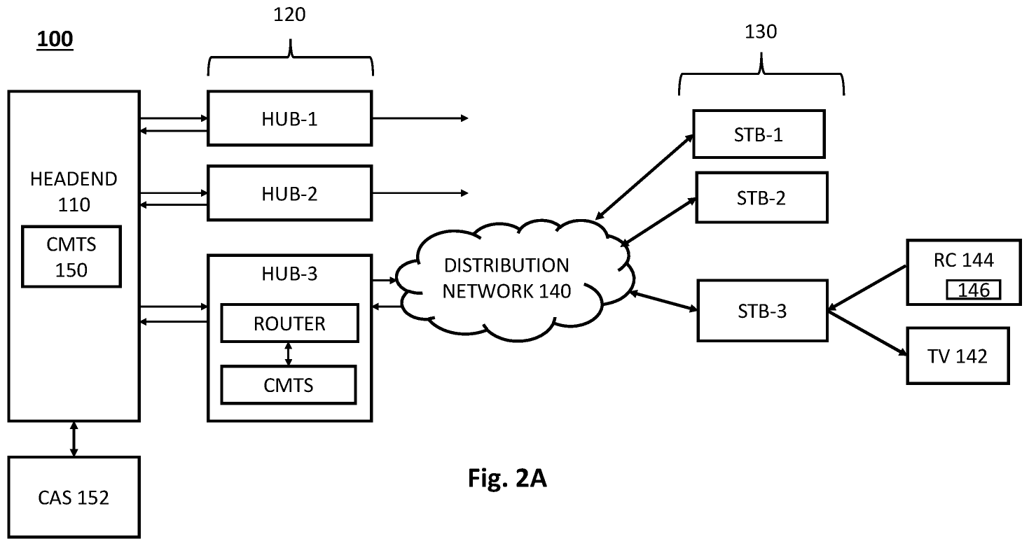

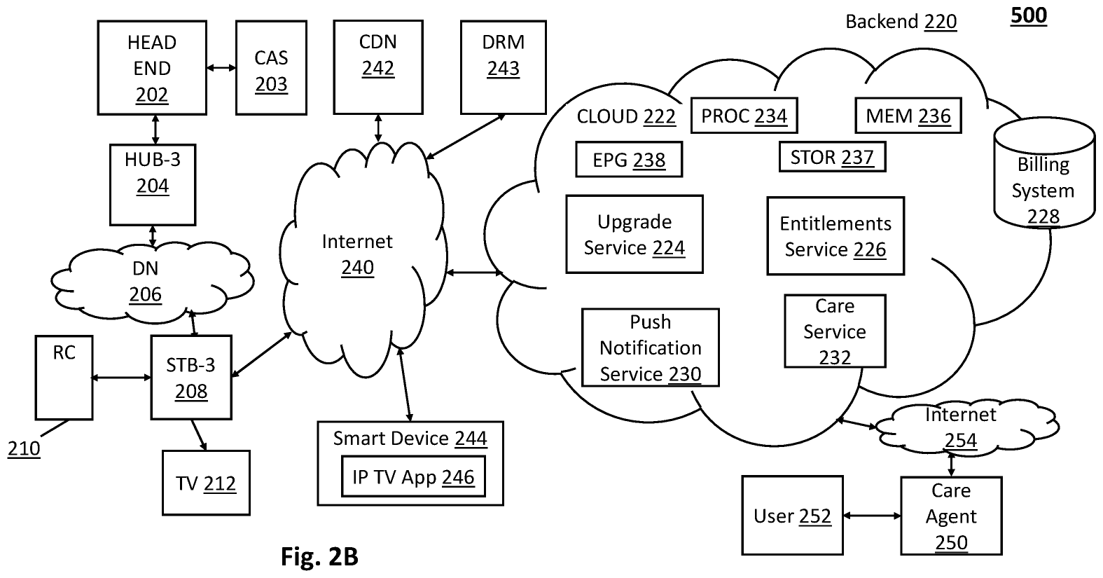

FIG. 2A is a block diagram of an example of a content delivery system (“CDS”) 100, such as a cable television system, for example, in which embodiments of the invention may be implemented. The CDS 100 in this example comprises a headend 110 in communication with each a plurality of hubs 120, here three hubs denoted as Hub-1 through Hub-3, for example. The headend 110 communicates with and provides program content to the three hubs 120. More or fewer hubs 120 may be provided. Each hub Hub-1 through Hub-3 communicates with and provides program content to a respective group of set-top boxes 130, in FIG. 1, the hub Hub-3 is shown coupled to three (3) set-top boxes 130, here STB-1 through STB-3, via a distribution network (DN) 140. The Hub-3 120 may also be coupled to other customer premises equipment (not shown), including modems and/or routers, via a distribution network 140. The set-top boxes 130 may belong to respective residential and/or commercial subscribers. Only the set-top boxes STB-1 through STB-3 that interact with the hub Hub-3 are shown for ease of illustration. It would be understood by one of ordinary skill in the art that the hubs Hub-1 and Hub-2 are also interact with respective set-top boxes and/or other customer premises equipment via respective distribution networks. In other examples, one distribution network 140 may support communications between multiple hubs 120 and their respective set-top boxes 130. In other examples, communications between the head end 110 and the one or more of the set-top boxes 130 may be direct, such as without using a hub 120. The CDS 100 may be a multi-service operator such as Charter Communications, Stamford, Conn.; Altice USA, Long Island City, N.Y.; and Cox Communications, Atlanta, Ga., for example.

FIG. 2A also shows a television (“TV”) 142 and a remote control (RC) 144 coupled to the set-top box STB-3 to control at least certain operations of the TV. The set-top box STB-3 switches between channels of the TV 142, decodes MPEG signals defining audio-visual programs corresponding to a respective channel that are received from the headend 110 for display on the TV associated with the STB-3 as analog signals, and conveys information entered by a user to the headend 110, for example. The STB-3 may be part of the TV 142.

FIG. 2A shows only one TV 142 and one remote control 144 coupled to one set-top box STB-3 for ease of illustration. It is understood that the other set-top boxes shown would have TVs and remote controls coupled to them. The TV 142 may be coupled to the set-top box STB-3 via a cable, such as a coaxial cable, for example.

The distribution network 140 may be any one of a number of conventional broadband communications networks that are available, such as a fiber optic network, a telecommunications network, a cable television network and the like. The distribution network 140 may comprise one or more of an optical network, a hybrid fiber coax (“HFC”) network for cable, an IP network, a Plain Old Telephone System (POTS) for ADSL, a terrestrial broadcast system like MMDS or LMDS, or a satellite distribution system like DBS, for example.

The headend 110 may include a cable modem communication system (“CMTS”) 150. Other components of the headend 110 related to providing program content to subscribers, such as a telemetry data capture device (“TDCD”) configured to receive data signals from the cable modem communication system (“CMTS”) 150, a session controller, a content asset module, user interface asset module, and a transport processor, for example, which are known in the art, are not shown or further discussed because they do not relate to embodiments of the present invention. These and other components of the head end 110, and the operation of the head end are described in more detail in US Patent Publication No. 201710230211, for example, which is assigned to the assignee of the present application and is incorporated by reference herein.

The Hub-3 in this example includes a router 152 configured to receive downstream data from the head end 110 and propagate upstream data toward head end 110. In addition, in this example, the Hub-3 may also include a cable modem termination system (“CMTS”) 154 configured to propagate downstream data toward the set-top box STB-3 via the distribution network 140 and to receive upstream data from the set-top box STB-3 via the distribution network 140. The other hubs 120 may be similarly configured.

A conditional access server (“CAS”) 152 is coupled to the headend 110 via a network. As is known in the art, the CAS 152 receives program content from a variety of sources (not shown) and scrambles the program content. One or more keys for descrambling the scrambled program content may be encapsulated in an entitlement management message (“EMM”). EMMs are provided by the CAS 152 to the headend 110, which may send the EMMs to respective set-top boxes 130 via the CMTS 150, for example, through the hubs 120 and the distribution network 130, for example, in a manner known in the art. The key(s) are then used to descramble the scrambled program content, in a manner known in the art.

FIG. 2B is a block diagram of an example of a system 200 for proactively refreshing entitlements for clients, in accordance with an embodiment of the invention. The system 200 of FIG. 2B includes a portion of the CDS 100 of FIG. 2A, here a head end 202, one hub-3 204, a distribution network (DN) 206, one set-top box 208 and its associated remote control 210 and a TV 212. It should be understood that while the Hub-1 and the Hub-2, and their associated distribution networks and set-top boxes (not shown in FIG. 1) in this example would also be coupled to the system 200 via a respective distribution network, they are not shown to simplify the illustration.

The system 200 also includes a portion of the backend 220 of the CDS 100 related to updating entitlements. In this example, the backend 220 resides at least partially in the cloud 222. The cloud 222 may be a private cloud, for example. The cloud 222 may also be hosted on a cloud platform, such as Amazon AWS or Microsoft Azure, for example.

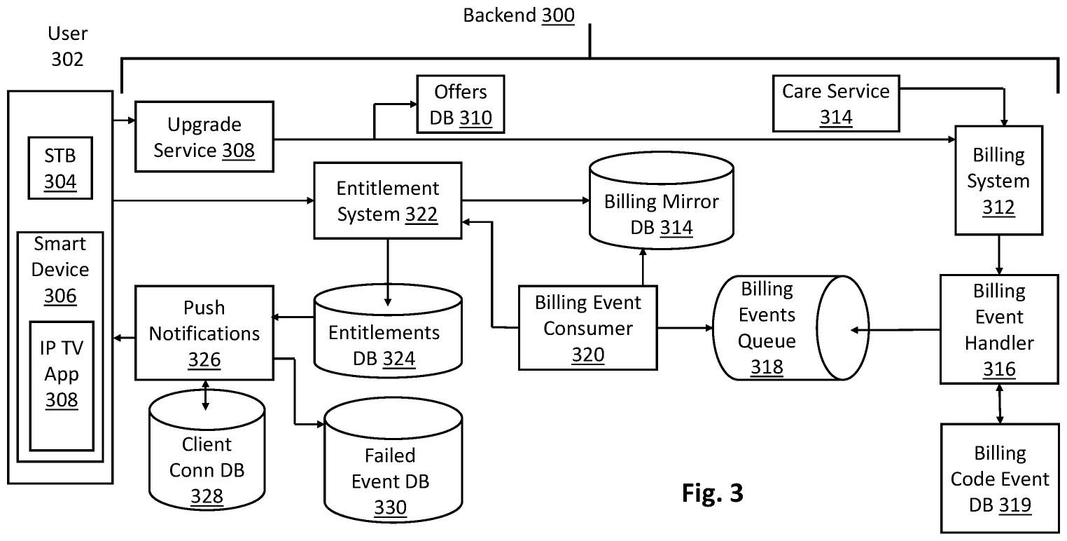

An upgrade service cloud App 224, an entitlements service cloud App 226, a push notification service cloud App 230, and a care service cloud App 232 are run by one or more virtual processing devices (PROC) 234, as is known in the art. A billing system 228 is also provided in the backend 220. The billing system may or may not be in the cloud 222. If not in the cloud 222, the billing system may be run by a computer or server in a data center, for example. Other virtual components, such as virtual memory (MEM) 236, virtual random access memory (“RAM”) or virtual dynamic RAM (“DRAM”), for example, and virtual storage (STOR) 237, such as a one or more hard drives or solid state storage devices (“SSDs”), are also provided, as needed. Additional cloud Apps are shown in FIG. 3 and described below.

In this example, an electronic program guide (“EPG”) cloud service 238 is also provided in the backend 220 to provide EPGs to set-top boxes, such as the STB-3, for display on user devices, such as the TV 212. In other examples, the EPG may be provided by a third party via a network, for example. The set-top box 208 communicates with the backend 220 via a network, such as the Internet 240 or a private network, for example.

A content delivery network (“CDN”) 242 provides program content to smart devices, such as the smart device 244. The CDN 242 works in conjunction with a digital rights management system (“DRM”) 243, in a manner known in the art. The DRM 243 may also be a cloud App in the backend 220 or may be a separate system, for example. The program content may be provided through the Internet 240 or a private network to smart devices, such as the smart device 244, for example, in a scrambled format. The DRM 243 also provides license keys for descrambling programs and channels to the CDN 242, which then provides the license keys to a respective smart device when requested by a respective smart device, as is known in the art. License keys may be provided to respective smart devices via a network, such as the Internet or a private network, for example,

An IP TV App 246 is shown residing on the smart device 244. The IP TV App 242 may be an iOS, Android, Roku, Apple TV, or other such App enabling access to program content on the smart device 244.

The upgrade service cloud App 224 is a web application that receives requests for service upgrades from set-top boxes and smart devices, such as the set-top box 208 and the smart device 240, processes the request, and returns a response to a user 302, via the set-top box or the IP TV App. The care service cloud App 232 is a web application that handles requests from a customer care agent, such as the customer care agent 246 in FIG. 2B, who communicates directly with users, such as the user 248 via a telephone, for example. The customer care agent 246 may communicate with the care service cloud App 232 via a network, such as the internet 250, for example.

The entitlement service cloud App 226 stores a mapping from the account subscription or subscriptions to actual TV channels in an entitlements database, shown in FIG. 3. Determining the actual TV channels a user 302 has access to, based on their subscription(s), is referred to as “calculating” the user's entitlements. There are also mappings of on demand and pay per view programs with respective channels.

The billing system 228 handles the billing and accounting aspects of the CDS 100 including user account information, user billing, user payments, and user subscriptions. The billing system 228 stores billing codes for each subscription and program purchase of each user. The billing system 228 may include one or more services and one or more databases, for example (not shown). User account information may include connection information for user devices, for example.

The entitlement system cloud App 226 receives the updated billing codes assigned by the billing system 228 in an event and determines the channels corresponding to the billing codes in the user's account based on the mapping. Once determined, the calculated entitlements are stored in the entitlements database 324 in association with the user's account number, for example. The current entitlements do not, therefore, need to be calculated again unless there is a change in a subscription. After calculating the user's entitlements, the entitlements system cloud App 226 posts an event to the push notification service cloud App 230 including the calculated channels.

The push notifications service cloud App 230 pushes the new entitlements, based on the new or updated subscriptions of the user 302, to the user on the user's active device, either the set-top box 208 or the smart device 240.

The billing system 228 stores account information for all the users of the system 200. When a purchase of a new subscription, on demand program, or a rental program is requested by a user 302, the billing system 228 may confirm that the user is an active subscriber, that the user is current in payments, and/or that if the purchase is made, a credit limit on the account will not be exceeded, for example.

As mentioned above, each user's account with the billing system 228 includes billing codes associated with the subscriptions and programs purchased by the user. When there is a change in a subscription or a new program is purchased, the billing codes for the current subscription or program are updated by the billing system 228. The billing codes identify the channels and programs the user is entitled to view on their devices based on the user's purchased subscriptions and purchased programs.

All changes in subscriptions requested by users via set-top boxes, smart devices, and customer care agents in this example are provided to a common component, in this example the billing system 228, in accordance with an embodiment of the invention. The subscription changes are provided from the billing system 228 to the entitlements service cloud App 226, which then provides the changes to the push notification service cloud App 230. Additional cloud Apps may be provided, as discussed below.

Messages may be sent between the backend 220 and set-top box 208 and the smart device 240, as well as among components in the backend 220, via HTTP, HTTPS, or UDP, messages, for example, as is known in the art. Messages may be sent between the set-top box 208 and the Internet 240, and between the Internet and the backend 220, via messages, for example. Messages may be sent between a smart device 244 and the Internet 240, and the Internet and the backend 220 via HTTPS message, for example. Messages between components of the backend 220 may be HTTP messages, because the cloud 222 is a secure environment.

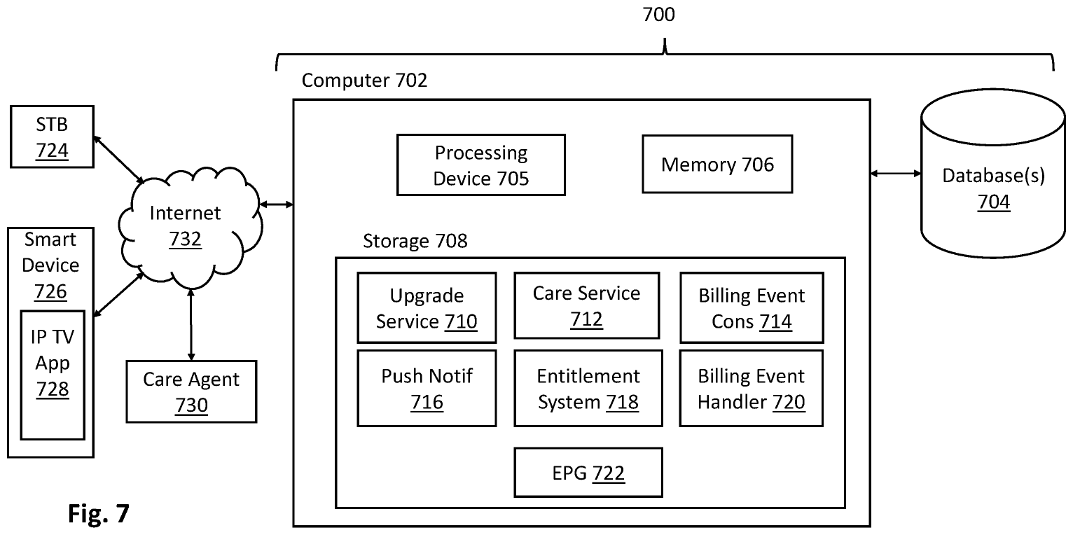

In other examples, some or all of the functions performed by the backend 220 described herein may be performed by one or more non-virtual processing devices, such as one or more central processing units, microprocessors, or microcontrollers, residing on one or more computers or servers under the control of suitable software, or combination of software and hardware, for example, as discussed with respect to FIG. 7. These functions may also be performed by a suitably configured application-specific integrated circuit, for example.

FIG. 3 is a more detailed block diagram of a backend 300, which corresponds to the backend 222 of FIG. 2B, in accordance with an embodiment of the invention. All or part of the backend 300 may reside in the cloud, for example, as discussed above. A user 302 interacts with the backend 300 via a set-top box 304 or via a smart device 306 including IP TV App 308. And the IP TV App 306 provides a video platform via a mobile App or through web browser so that content may be viewed by mobile devices, such as a smart phone, iPad, or other smart device. The set-top box 304 and the IP TV App 306 communicate with the backend 300 via a network, such as the Internet 242 of FIG. 2, which is not shown in FIG. 3 to simplify the illustration. The set-top box 302 and the IP TV App 304 may communicate with the backend 300 via a web socket/server sent events protocol over the Internet, for example, which allows for duplex communication over a single TCP connection.

An upgrade service cloud App 308 corresponds to the upgrade service cloud App 224 of FIG. 2. An offers database 310 (“offers DB 310” in FIG. 3) contains video packages and associated information that are available for purchase by the user 302. Different packages may include different sets of channels, some premium channels, or all premium channels, for example. Each package includes a respective price. The upgrade service cloud App 308 obtains the video packages and associated information, including the channels included in each package and the price, and provides them to the requesting device of the user 302.

A billing system 312 corresponds to the billing system 228 of FIG. 2. As discussed above, the billing system 312 may or may not be part of the cloud. If the billing system 312 is not part of the cloud, other components of the backend 300 may communicate with the billing system 312 via a network, such as a private network or the Internet, for example. When a purchase of a new subscription, an on demand program, or a purchase of a rental program is initiated by a user 302, the billing system may confirm that the user is qualified to make the purchase and associate billing codes corresponding to the purchased subscription or program to the user's account.

A care service cloud App 314 corresponds to the care service cloud App 232 of FIG. 2. A billing mirror data database 314 (“billing mirror DB 314 in FIG. 3) stores replicated billing account data from which other Apps may obtain billing data.

A billing event handler cloud App 316 in this example receives new billing events generated by the billing system 312 related to changes in billing codes when a new subscription and/or program is purchased. The billing event handler cloud App 316 posts new billing code events to a billing events queue cloud App 318, which stores the new billing code events. The billing events queue cloud App 318 may be configured to send a confirmation message to the billing event handler cloud App 316 when a new billing code event is received. If a confirmation message is not received within a predetermined period of time, the billing event handler cloud App 316 may store the new billing code event in a billing code event handler database 319. The billing event handler cloud App 316 may be configured to periodically retrieve stored events from the billing event database 319 and retry posting the retrieved billing code events to the billing events queue cloud App 318.

A billing events consumer 320 monitors the billing events queue 318 for new billing code events. When a new billing code event is identified, the billing events consumer 320 retrieves the event and identifies the user account to which the billing code event relates. The billing events consumer 320 forwards the billing code event and the identified user account to the billing mirror database 314. The billing events consumer 320 also informs an entitlement system cloud App (“entitlements system”) 322 that a change has taken place in the user account. The billing events consumer 320 may process the events, if necessary, to format the event for the entitlements system cloud App 322, for example.

The entitlements system 322 stores a mapping of each available subscription, each on demand program, and each pay per view program to respective TV channels in an entitlements database 324. Since the channels that respective programs from a respective source (NBC, ABC, CBS, HBO, for example) may air on may vary based on the geographic location of the user 302, the channels the user's set-top box 304 need to tune to in order to display a respective program need to be determined. For example, program content provided by CBS may air on channel 2 in New York and on channel 7 in Florida. The mapping correlates the codes associated with respective subscriptions with corresponding channels in respective geographic areas. In one example, each package, individual on-demand program, individual rental program, and other individual service is associated with a respective code, as discussed above with respect to the billing system 312. One or a few billing codes may identify multiple or all of the corresponding channels. The billing codes may be correlated with respective channels in respective geographic areas in one or more tables, for example. Determining the actual TV channels a respective user 302 has access to, based on their subscription(s), is referred to as “calculating” the user's entitlements. Once calculated and stored in an entitlements database 324, the calculated entitlements for a respective user 302 do not need to be calculated again unless there is a change in the user's subscription. The mapping is applicable to the set-top box(es) 304 and the smart device(s) 306 of the user 302.

When the entitlements system 322 is informed of a new billing code event related to a respective user account by the billing events consumer 320, the entitlements system retrieves all or at least the new billing codes associated with the user's account from the billing mirror database 314, based on an identification of the respective user account. The entitlements system 322 then calculates the entitlements, as described above. After calculating the user's entitlements, the entitlements system 322 stores the calculated entitlements an entitlements database 324 and posts an event to a push notification service cloud App 326, which corresponds to the push notifications service cloud App 230 in FIG. 2B.

The push notifications service cloud App 326 pushes the new entitlements, based on the new or updated subscriptions of the user 302, to the user 302 on the user's active device or devices, either or both the set-top box 304 and IP TV App 306 on the user's mobile device, in this example. Connection information for each device (each set-top box 304 and mobile device having an IP TV App 306) is stored in a client connection database 328. The push notifications service App 326 obtains the connection information for a respective device from the client connection database 328. In one example, a failed event database 330 stores failed push notification events for retry by the push notification service cloud App 326 at a later time, as discussed further below. Providing the failed event database 330 and retrying pushed notifications are optional.

It will be apparent to those skilled in the art that alternative architectures of the backend 300 of FIG. 3 may be provided to achieve the functions of identifying billing code events, calculating entitlements, and pushing entitlements to user devices, as described herein. In addition to the alternatives discussed above, one or more of the billing mirror database 314, the billing code event database 319, the entitlements database 324, the client connection database 328, and the failed event database 330 in FIG. 3 may be combined in a single database. In addition, functions of multiple cloud Apps may be combined, for example.

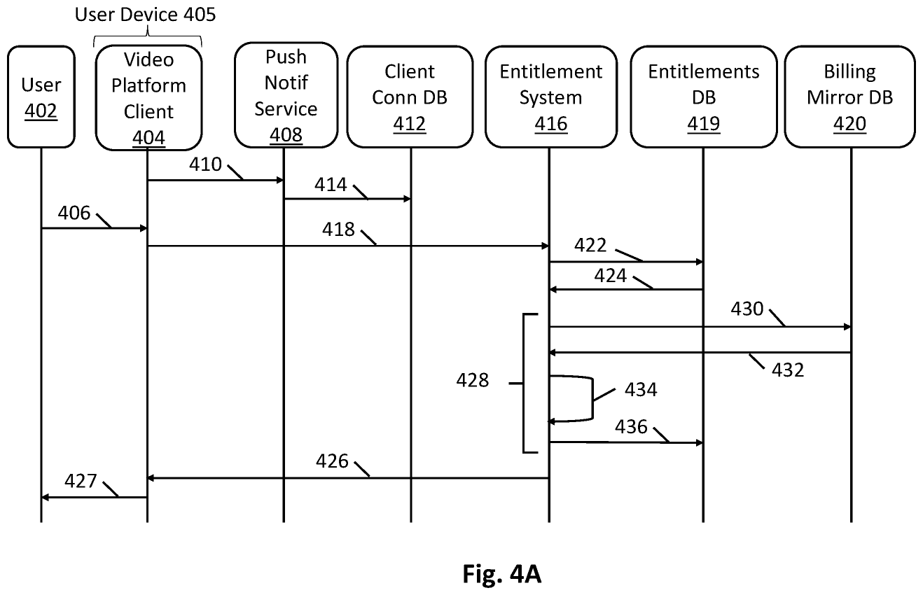

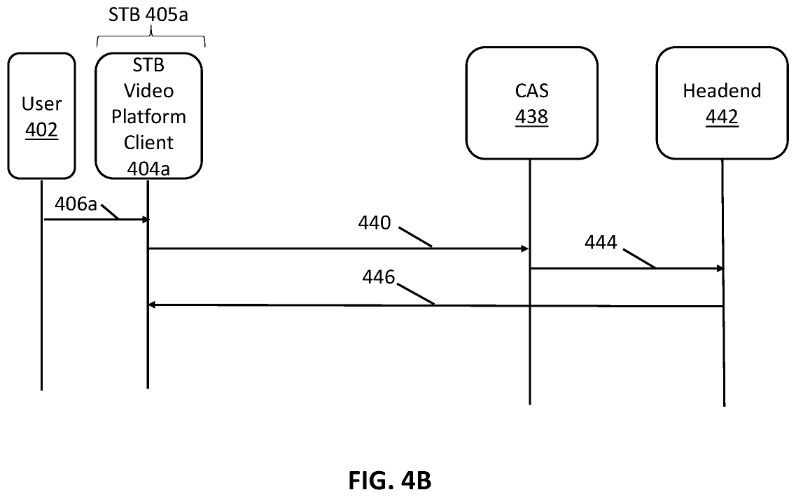

FIG. 4A is a flow diagram of an example of at least a portion of a boot up sequence 400 during which client devices are provided with current entitlements to subscriptions and programs, in accordance with an embodiment of the invention. The boot up sequence 400 is implemented when a client device, such as the set-top box 304 and the smart device 306 of FIG. 3, boots when the set-top box is turned on or when the IP TV App 306 is opened on the smart device, for example. In this example, a user 402 turns on the video platform client 404 of their user device 405 (either a set-top box or a smart device), at Step 406. The video platform client 404 establishes a persistent connection with a push notification service 408 in the backend, such as the backend 300 of FIG. 3, across the network, at Step 410. The network may be the Internet 242 of FIG. 2, for example. In this example, the persistent connection is established through web sockets or Server-sent events, in a manner known in the art. The push notification service 408 receives HTTP connection information from the respective video client 404 and stores the HTTP connection information in a client connection database 412 (“client conn DB 412” in FIG. 4A), at Step 414. HTTP connection information may include the IP address of the user device, HTTP headers, and data that needs to be exchanged, for example, as is known in the art. The connection is persistent for the entirety of the session, until the video platform 404 on the set-top box or smart device initiating the session is turned off.

The video platform client 404 also sends a “get entitlements” request to the entitlement system App 416, at Step 418. The entitlement system 416 retrieves the entitlements for the user 402 from the entitlements database 419, at Step 422. The entitlements may be located in the entitlements database 419 by searching for the account number of the user whose device is being boot up, for example. The entitlements database 419 returns the entitlements for the requesting video platform client 404 to the entitlement system 416, at Step 424.

The entitlement system 416 returns the entitlements to the video platform client 404. The video platform client 404 displays the received entitlements to the user 402 on the TV or mobile device associated with the video platform client.

If the entitlement system 416 cannot retrieve the entitlements from the entitlements database 419 because the entitlements are not yet stored in the entitlements database, an alternative flow 428 is followed in this example in which the entitlement system requests the account information, including the subscriptions and programs purchased by the user 402, from the billing data mirror database 420 (“billing mirror DB 420” in FIG. 4A), at Step 430. As discussed above with respect to FIG. 3, the billing data mirror database 420 obtains the account information from the billing system 411 after purchases are made. The account information is provided by the billing data mirror database 420 to the entitlement system 416, at Step 432. The entitlement system 416 calculates the entitlements based on the account information, at Step 434, and stores the calculated entitlements in the entitlements database 420 at Step 436, so that they can be retrieved on the next and subsequent boot ups. The entitlements are then sent to the video platform client 404 at Step 426, where they may be displayed to the user 402, at Step 427. The entitlements may be displayed by automatically opening the EPG, which shows the unlocked channels and programs, or when the user opens the EPG, for example.

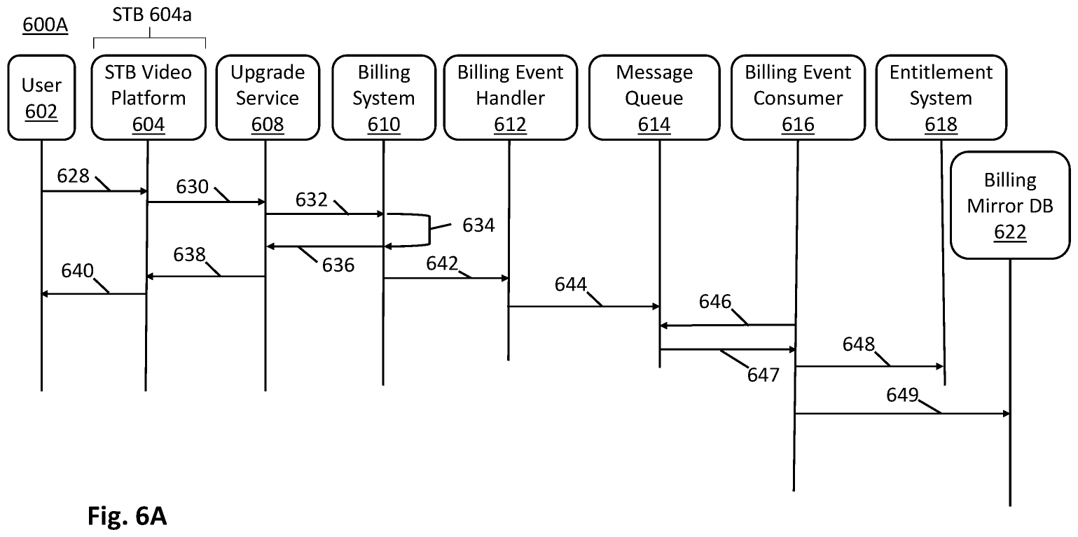

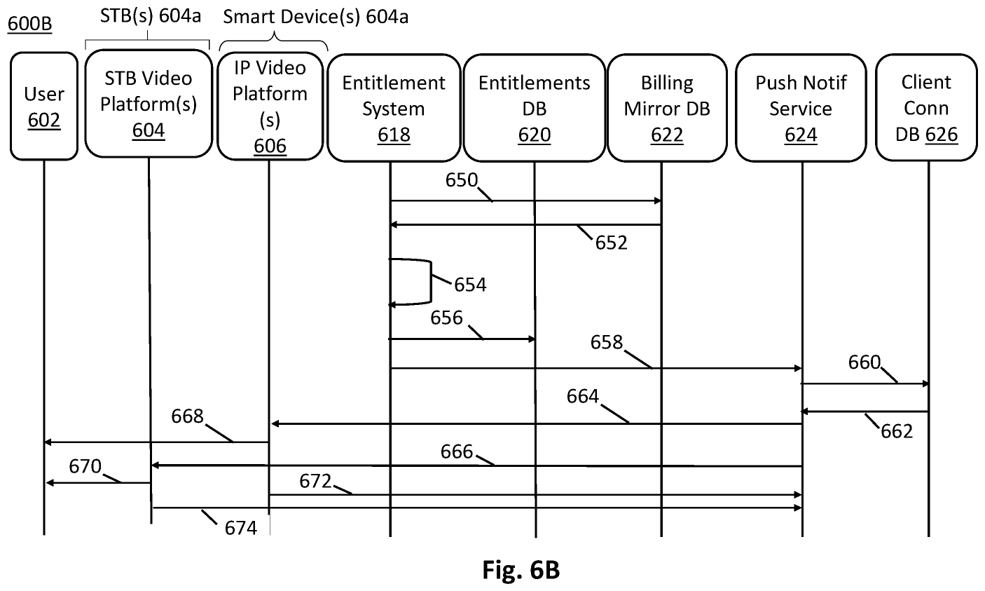

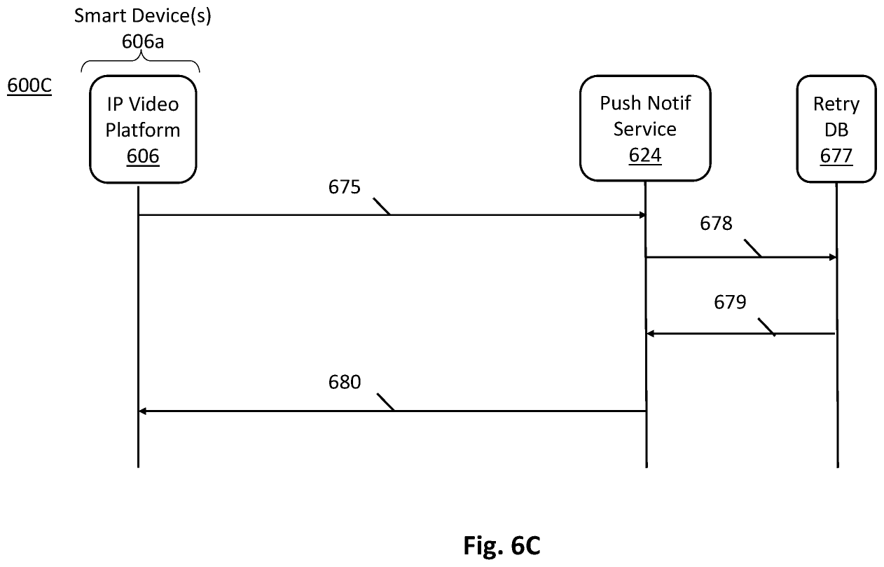

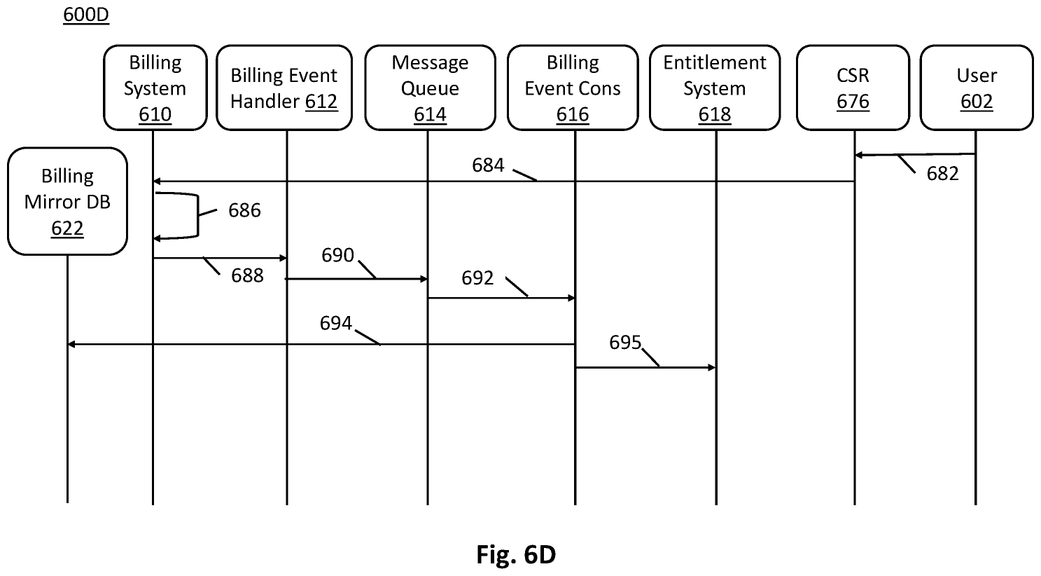

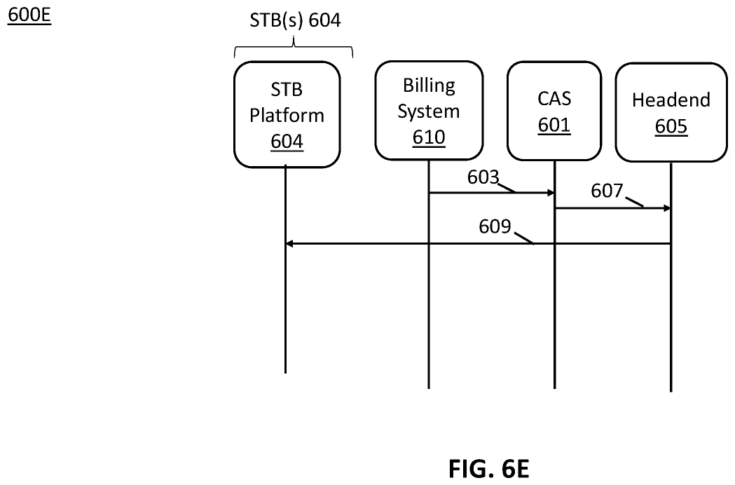

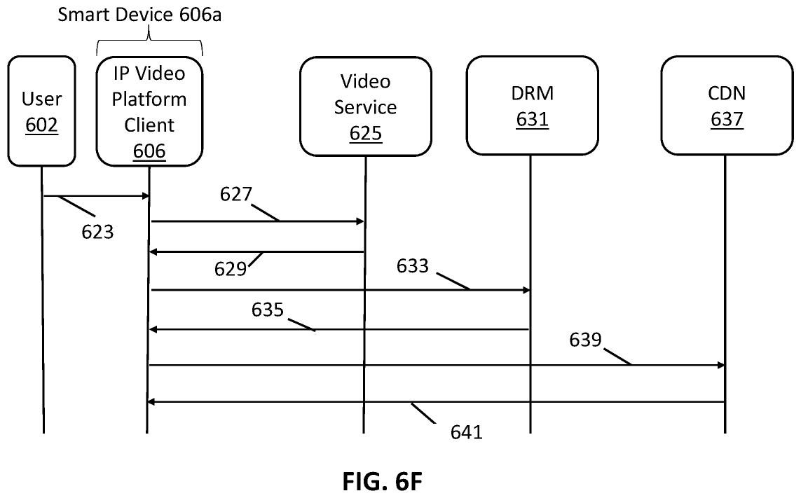

In addition, keys for decoding the scrambled program content provided on the channels the user is subscribed to and the programs purchased by the user are provided to the video platform client 404 of the user device 405. FIG. 4B is a flow diagram of an example of at least a portion of a process for providing EMMs to a video platform client 404a of a set-top box 405a on boot up. When the user 402 turns on the set-top box 405a, in Step 406a, the STB video platform client 404a registers with the CAS 438 informing the CAS of its status, in Step 440, in a manner known in the art. The STB video platform client 404a may register via the distribution network 206 of FIG. 2, for example. When the video platform client 404a registers with the CAS 438, the video platform client establishes a connection with the CAS. The CAS 438 sends the current EMMs for the set-top box 405a, which are stored by the CAS in a database (not shown), to the headend 442 with the connection information for the set-top box 405a, via a network, in Step 444. As discussed below with respect to FIG. 6A and FIG. 6E, the billing system (not shown in this view) sends a message to a CAS 438 to inform the CAS that the user is entitled to channels in a new subscription or a new program. The headend 442 sends the EMMs to the video platform client 404a of the set-top box 405a that is booting, based on the connection information, also via the distribution network 206 in FIG. 2, for example, in Step 446.

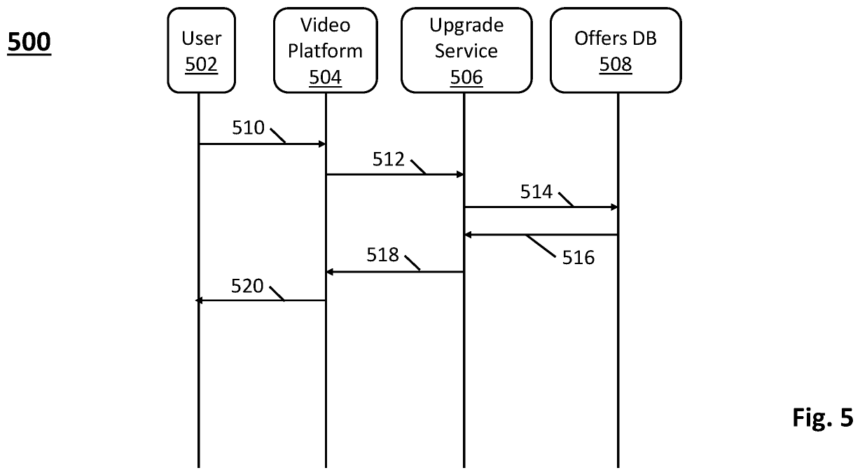

FIG. 5 is a flow diagram of an example of a method 500 of obtaining offers, in accordance with an embodiment of the invention. A user 502 obtains offers in this example from the upgrade service cloud App 506 and the offers database 508. When a user 502 desires to upgrade their service to obtain access to additional channels, for example, the user request offers on a graphical user interface presented on their video platform, at Step 510. A request for available subscriptions is sent from the video platform 504 to the upgrade service cloud App 506, at Step 512. The upgrade service cloud App 506 queries the offers database 508 for available offers, at Step 514, and the offers database returns the available offers to the upgrade service cloud App 506, at Step 516. The upgrade service cloud app 506 provides the available offers to the video platform 504, in Step 518, for display to the user 502, in Step 520.

FIG. 6A-FIG. 6D are portions of a flow diagram of an example of a portion 600A of a method of purchasing an offer for a subscription or program via a set-top box, a smart device, or a customer service representative and pushing entitlements to the purchased subscription or program to all devices associated with the user, in accordance with an embodiment of the invention. In the example of FIG. 6A, the offer is purchased by a user 602 via a set-top box video platform 604 on a set-top box 604a, and notification of the purchase is pushed to the one or more IP video platforms 606 of the smart devices 606a of the user and to the one or more set-top boxes 604a of the user, in FIG. 6B. In the method 600A of FIG. 6A, the upgrade service cloud App (“upgrade service”) 608, the billing system 610, the billing event handler cloud App (“billing event handler”) 612, the message queue cloud App (“message queue”) 614, the billing event consumer cloud App (“billing event consumer”) 616 (“billing event cons 616” in FIG. 6A), and the entitlement system cloud App (“entitlement system”) 618 are shown.

In FIG. 6A, the user 602 initiates a purchase of an offer selected during the method 500 of FIG. 5, via a graphical user interface displayed by the set-top (“STB”) box video platform 604 on a TV or other display device connected to the set-top box 604a, via the remote control. Upon selection of the purchase option on the graphical user interface, at Step 628, a purchase request is sent by the STB box video platform 604 to the upgrade service 608, at Step 630. The upgrade service 608 sends the purchase request to the billing system 610, at Step 632. It is noted that the method portions 600A and 600B proceed in the same manner if the user 602 initiates a purchase via the IP video platform 606 on one of the smart devices 606a of the user.

The billing system 610 validates the user 602, confirms in this example that 1) the user's account is current (fully paid); 2) the purchase meets the user's credit limits; and 3) the user is a subscriber to video services provided by the content delivery service, for example, at Step 634, as discussed above. The billing system 610 sends a purchase status message to the upgrade service 608, at Step 636, which then sends a purchase status message to the STB video platform 604 for display to the user 602, at 640. If the billing system 610 determines that the user meets all the requirements for the purchase, the purchase status message is a purchase acknowledgement message. If the billing system 610 determines that the user 602 does not meet all the requirements for the purchase, the purchase status message is a purchase denial message. If a purchase denial message is received, the user 602 may then call customer service to resolve the issue by increasing their credit or making a current payment, for example.

If the billing system 610 determines that the user meets all the requirements for the purchase, at Step 634, the billing system also generates a billing code event, which includes the new subscription or program purchase information, including billing codes for the purchased subscription or program. The billing code event is published to the billing event handler 612, at Step 642. The billing event handler 612 provides the billing code event to the billing events queue 614, at Step 644. In another example, the billing system 610 could provide billing code events directly to the message queue 614, in which case the billing event handler 612 would not be needed.

The billing event consumer 616 periodically checks the message queue 614 for a new posted billing code event, in Step 646. The message queue 624 may be checked from about one 2 second to about 60 seconds or more, for example, such as every second, every few seconds, such as 3-5 seconds, every 30 seconds, every 60 seconds, or another time period, for example, depending on how fast it is desired to push entitlements to user devices and the capabilities of the network. When a new posted billing code event is found, the new posted billing code event is consumed by the billing event consumer, at Step 647. The billing event consumer cloud App 616 then sends an entitlement change notification to the entitlement system 618, based on the consumed billing code event, at Step 648. The entitlement change notification includes the billing code or codes of the purchased subscription or program and an identification of the user account, which may be a user account number, for example. The billing event consumer 616 also forwards the billing codes in the billing code event to the billing mirror database 622, in Step 649. The billing mirror database stores the billing code in association with the user account number.

In the portion 600B of the method 600 that continues in FIG. 6B, the entitlement system 618, an entitlements database 620, a billing mirror database 622 (“billing mirror DB 622” in FIG. 6A), a push notification service cloud App (“push notification service” or “push notif service 624” in FIG. 6B) 624, and a client connection database 626 (“client conn DB 626” in FIG. 6B) are used. After receiving the entitlement change notification at Step 648, the entitlement system 618 requests the updated account information after the last purchase of the subscription or program, from the billing data mirror database 622, based on the user account number, at Step 650. The billing mirror database searches for the updated account information and provides the updated account information to the entitlement system 618, in Step 652.

The entitlement system 618 calculates the current entitlements in light of the updated account information, at Step 654. The entitlement system 618 stores the updated entitlements in the entitlements database 620 so that the updated entitlements are available the next time a user devices boots, in Step 656. The entitlement system 618 also sends the updated entitlements to the push notification service cloud App 624, at Step 658.

The push notification service cloud App 624 retrieves connection information for all of the devices of the user 602, including the user device making the purchase, from the client connection database 626, in Step 660. The client connection database 626 returns the connection information to the push notification service cloud App 624, in Step 662.

Using the connection information, the push notification service 624 in this example pushes all the entitlements, including the new entitlements, to the IP video platform(s) 606 of the one or more smart device(s) 606a of the user, at Step 664. The push notification service 624 in this example also pushes all the entitlements, including the new entitlements, to the one or more STB video platform(s) 604 of the one or more set-top boxes 604a of the user. In other examples only the new entitlements may be pushed to the user devices in Step 664 and 666.

The pushed entitlements include instructions to the set-top box(es) 604a and smart devices 604b to remove the icon indicating that the channel or program is locked, such as the icon 12 in FIG. 1A and FIG. 1B, for example, or other indication that the channel or program is locked, for channels and/or programs that a respective user had not been previously subscribed to but is now subscribed to. For example, in FIG. 1A, the user might not have subscribed to HBO or a package that included HBO. Channel 28, on which HBO program content is displayed to the respective user, therefore included a locked icon 12. If the user purchases a subscription that includes HBO, then the locked icon 12 associated with channel 28 would be removed by the user's active set-top box(es) 604a and/or active smart device(s) 606 after receipt of the pushed entitlements.

It is noted that in this example, entitlements are pushed to all of the user devices for which connection information is available in the client connection database 626. Only active devices, however, will receive the entitlements and update the EPG displayed on the active devices. As discussed above, the user devices that are not currently active will receive all the current entitlements when they are turned on and rebooted.

Unlocking locked channels after receiving entitlements during boot up by set-top boxes and smart devices is well known in the art. The user's set-top box(es) and smart device(s) may unlock channels when they receive pushed entitlements in the same manner that they unlock locked channels after receiving entitlements during boot up, for example. In another example, the EPG cloud App 238 in FIG. 2B or another cloud App may be configured to update the EPG with the new entitlements for respective user devices and send the updated EPG to the respective user device.

The IP video platform 606 displays the updated entitlements to the user by displaying the updated EPG on a display screen on the smart device 244 of FIG. 2B, for example, in Step 668. The STB video platform 604 displays the pushed updated entitlements to the user by displaying the updated EPG on the TV 212 of FIG. 2B, for example, at Step 670. The updated EPG may be displayed automatically after being updated or when opened by the user, for example.

The IP video platform 606 of a respective smart device 606 returns a confirmation message to the push notification service 624, in Step 672. The STB video platform 604 of a respective set-top box 604a returns a confirmation message to the push notification service 624, in Step 674. The confirmation message may be an HTTP status message, such as an HTTP status message 200, which indicates that the message was successfully sent and received, for example.

FIG. 6C is a flow diagram of an example of the portion 600C of an optional method for handling failed push notifications. If a respective confirmation message is not received by the push notification service 624 within a predetermined period of time, or if a failure message is received, for example, the push notification service may try again one or more times. Failure to receive confirmation messages may be due to network problems or turning off of the STB video platform 604 and/or the IP video platform 606, for example. A failure message may be a HTTP failure message, such as an HTTP status message 500, for example. The predetermined period of time here may be from several seconds up to one minute, for example.

After the predetermined period of time without receiving a confirmation message from the IP video platform 606, for example, in Step 675, the push notification service 624 may send the push notification to the retry (or failed event) database 677 for storage, in Step 678 in Step 678, so it can be sent again at a later time. Similarly, if the push notification service 624 does not receive a confirmation message from the set-top box platform 604, and the other active devices of the user, within the predetermined period of time, or if the push notification service receives a failure message from set-top box platform, the push notification service 624 may send the push notification to the retry (or failed event) database for storage, which is not shown in FIG. 6C to simplify the Figure. The push notifications may be stored in the retry (or failed event) database 677 in association with the user's account number and connection information for the user devices that have not sent a confirmation message or have sent a failure message. A timestamp of when the push notification was first sent may also be included. If a failure notification is received by the push notification service 624 in Step 675, The push notification may be stored in the retry database 677 (retry DB 677″ in FIG. 6C) in Step 678 immediately after receiving a failure notification, in Step 675.

After a second predetermined period of time after storage of the push notification in the retry database 677, for example, the push notification service 624 is configured to retrieve the pushed notification, in Step 679 and send the retrieved push notification to the IP video platform 606 and other user devices that have not sent a confirmation message or from which a failure message has been received, in Step 680. Steps 675-680 may be repeated until a confirmation message is received from all the user devices or the process times out. For example, the push notification service 624 may be configured to send a first retry one (1) second after failure to receive a confirmation message or after receipt of an HTTP failure message, for example. The push notification service 624 may be further configured to send the next and subsequent retries in an exponentially increasing pattern, such as after 3 seconds, 5 seconds, and 8 seconds after failure to receive a confirmation message or from receiving a failure message, for example. In another example, the push notification service 624 may be configured to send another push notification in constant intervals, such as every 5 seconds, for example. Retries may continue for a predetermined number of times, such as 3 to 10 times, for example. After the predetermined number of retries, the push notification service 624 may stop attempting to send push notifications. The user 602 may then need to contact customer service for assistance, for example.

FIG. 6D is a flow diagram of an example of the portion 600D of the method 600 for updating entitlements purchased through a customer service representative (“CSR”) 676. This example uses the billing system 610, the billing event producer handler 612, the message queue 614, the billing event consumer 616, the entitlement system 618, and the billing mirror database 622. The user 602 contacts the CSR 676 manually, such as via a phone call, for example, to change to change their subscription, such as to upgrade, or to buy or rent an on-demand program, for example, at Step 682.

The CSR 676 sends a purchase message to the billing system 610, at Step 684. The purchase message includes information concerning the subscription/program purchased and the user 602, for example. As above, the billing system 610 validates the user 602 by confirming that the user's account is current, the purchase meets the user's credit limits, and/or that the user is active, for example, at Step 686. If the billing system 610 determines that the user meets all the requirements for the purchase, the billing system 610 generates and sends a purchase event message to the billing event producer 612, at Step 688.

The additional Steps are similar to those described with respect to FIG. 6D. The billing event handler 612 generates a billing code event based on the purchase event message and posts the billing code event to the message queue 614, at Step 690. The billing event posted to the message queue 614 is consumed by the billing event consumer 616, at Step 692. The billing event consumer 616 sends the new entitlements to the billing mirror database 622, at Step 694. The billing event consumer 616 also sends an entitlement change notification to the entitlement system 618, at Step 694. The entitlement system 618 then continues as discussed above with respect to Step 650 in FIG. 6B and the subsequent Steps.

FIG. 6E is a flow diagram of an example of a portion 600E of the method 600 for providing keys for descrambling program content to set-top boxes so that a user 602 can view program content on channels in purchased subscriptions and view purchased programs on the user's client devices, after entitlements are pushed to set-top boxes. In FIG. 6E, one or more set-top box(es) 604a, each with a respective STB platform client 604 are shown. After Step 634 in FIG. 6A, the billing system 612 also sends a message to a CAS 601, such as the CAS 203 of FIG. 2B, in Step 603, to inform the CAS that the user 602 is entitled to channels in a new subscription or a new program. As discussed above with respect to FIG. 4B, the CAS 601 stores EMMs for respective channels and programs and provides the EMMs to the CAS during boot up of a set-top box, as shown and described above with respect to FIG. 4B. The CAS 601 retrieves the EMMs associated with the channels of the new subscription or the program from a database (not shown) and sends them to a headend 605, such as the headend 202 of FIG. 2B, in Step 607. The headend 605 sends the EMMs to the user's one or more set-top boxes 604a using the connection information obtained by the CAS 601 during the boot up of the respective set-top box 604a, via a network, such as the distribution network 206 in FIG. 2B, in Step 609. The set-top box 604 can descramble and cause display of the program content received on the channels of the purchased subscription and/or the purchased program using the EMMs, in a manner known in the art.

It is noted that EMMs are not provided to smart devices on boot up as they are for set-top boxes. Instead, license keys to stream channels and programs are retrieved by a respective smart device from a DRM, such as the DRM in FIG. 2B, when the smart device tunes to the respective channel or program, as is known in the art FIG. 6F is a flow diagram of an example of a portion of a process for providing license keys to a smart device 606a including an IP video platform client 606, to enable viewing of scrambled program content after entitlements after entitlements are pushed to the smart device. When the smart device 606a tunes to a respective channel or program, via the IP video platform client 606, in Step 623, the smart device sends a message to a video service 625, in Step 627. The video service 625 receives requests for creating streaming sessions from smart devices and creates the streaming sessions, including a streaming URL and DRM tokens. The video service 625 may be part of the backend of the content delivery system, such as in the backend 300 of FIG. 3, for example. The smart device 606a may contact the video service 625 in the backend 300 via the Internet 240 of FIG. 2, for example.

In response to the tuning request, the video server 625 provides streaming session information, including the streaming URL and the DRM token for the tuned to channel to the smart device 606a, in Step 629. The smart device 606a sends the received DRM token to the DRM 631, with an identification of the smart device and the user, for example, in Step 633. The DRM 631 sends the license keys for the requested DRM token, in Step 635. License keys are stored by the DRM 629 in a database (not shown). The license keys may also be sent to the smart device 606a via the Internet 240 of FIG. 2B, for example. The smart device 606a then requests that the program content on the tuned to channel or the selected program be downloaded from the CDN 637, in Step 639. The CDN 637 sends scrambled program content to the smart device 606a, in Step 641. The program content is descrambled by the IP video platform 606a using the licenses keys and displayed to the user 606a by the smart device 606a, in a manner known in the art.

While in the examples above, processes are performed by cloud Apps under the control of one or more virtual processing devices and storage devices, corresponding processes may be performed by one or more non-virtual processing devices and other non-virtual components, such as non-virtual databases. FIG. 7 is a block diagram of an example of a hardware platform 700 configured to perform the processes described above with respect to the backend 300 of FIG. 3. The hardware platform 700 in this example includes a computer 702 and one or more databases 704. The computer 702 includes a processing device 705, such as a central processing unit, microprocessor, or microcontroller, for example. Memory 706, such as RAM or DRAM, and storage 708, such as one or more hard drives and/or SSDs, is also provided. Software Apps or modules for controlling operation of the processing device 704 may be stored in the storage 708, including an upgrade service 710, a care service 712, a billing event consumer 714, a push notification 716, an entitlement system 718, a billing event handler App 720, and an EPG App 722, which operate in the same manner as discussed above with respect to the corresponding cloud Apps in FIGS. 2-6C. In the example, of FIG. 7, however, each module or App 710-720 causes the processing device 705 to perform the described functions instead of causing one or more virtual processors to perform the described functions.

The database(s) 704 represents one or more databases corresponding to the offers database 310, the billing data mirror database 314, the entitlements database 324, and the failed event (or retry) database 330 of FIG. 3. One or more of the database(s) 704 may be database servers, for example.

A set-top box 724, a smart device 726 including an IP TV App 728, and a care agent 730 are shown in communication with the hardware platform via a network, such as the Internet 732, for example.

The computer 702 may also be configured in whole or in part to implement aspects of embodiments of the invention by hardware, such as an application-specific integrated circuit (ASIC), or by a combination of hardware and software, for example.

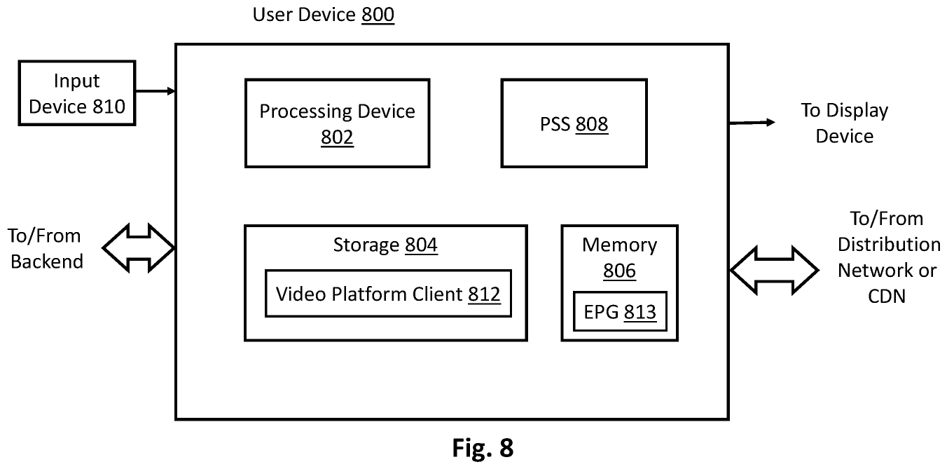

FIG. 8 is a block diagram of a user device 800 that may be used in embodiments of the invention. As discussed above, the user device 800 may be a set-top box and/or a smart device, such as a smart phone or tablet, for example. In one example, the user device 800 operates in a conventional manner except that the user device is configured to receive and store entitlements while the user device is active, as well as after boot up, regardless of whether the user device is a set-top box or a smart device. The user device includes a processing device 802, storage 804, memory 806, and, when the user device is a set-top box, a program signal stream (“PSS”) block 808.

The processing device 802 controls operation of the user device, under the control of software, a combination of hardware or software, or by hardware, such as an ASIC, for example. The processing device 802 may be a central processing unit, a microprocessor, or a microcontroller, for example.

If the user device 800 is a set-top box, the processing device 802 may send program signals for display on a TV and may send control signals to the TV based on the input of an input device 810 to control certain TV functions, such as turning on and off the TV, controlling the volume of the TV, etc. In addition, if the user device 800 is a set-top box, the input device 810 is a remote control and input components on the set-top box itself, for example. If the user device 800 is a smart device, programs are displayed on the display screen of the smart device and input device may be a keyboard of the smart device, for example.

The storage 804 in this example is provided to store software programs for controlling operation of the processing device 802, for example. The storage 804 may also store recorded programming content in the case of a set-top box DVR, for example. A video platform client (“video platform”) 812 is shown in the storage 804. As discussed above, if the user device 800 is a set-top box, the video platform 812 is a set-top box video platform, and if the user device 800 is a smart device, the video platform is an IP streaming video platform.

The processing device 802, under the control of the video platform 812, determines the channel to be tuned to, based on the input of the input device 810. The PSS block 808 in a set-top box represents components of the user device 800 dedicated to tuning to a respective program stream of a plurality of program signal streams provided by the headend of the content delivery system and selected by a user, descrambling the programming content, which may be in the form of MPEG program signals, for example, performing trick functions on the programming content, and performing other functions related to the program signal stream, as is known in the art, for example. These components and their operation are well known in the art. If the user device 800 is a set-top box, the set-top box may provide a program signal stream to the TV via a coaxial cable, for example.

If the user device 800 is a smart device, the processing device 802 descrambles program content with license keys and causes display of program content under the control of the IP video platform 812.

The memory 806, which may be random access memory or virtual dynamic RAM (“DRAM”), for example, may store EMMs and license keys received from the headend or the CDN to descramble scrambled program content, depending on whether the user device is a set-top box or a smart device. The memory 806 may also store the EPG 813 received from the backend, such as the backend 220 of FIG. 2B, for example. Display of the EPG 813 and removal of icons or other indications in the EPG or other graphical user interface may also be performed by the processing device 802, under the control of the video platform 812. The memory 806 may also store other information related to the operation of the user device 800, as is known the art.

Examples of implementations of embodiments of the invention are described above. Modifications may be made to those examples without departing from the scope of the invention, which is defined by the claims, below.

1. A method of managing entitlements to program content of a content delivery system, comprising:
receiving a request, from a user, by a processing device, to subscribe to a video package or to purchase a video program from the content delivery system, the user having at least one user device configured for watching the program content;
calculating at least one entitlement resulting from the subscription or purchase;
retrieving connection information for each the at least one user device, from a database; and
pushing the at least one calculated entitlement to each at least one user device by the processing device, via a network, using the connection information.

2. The method of claim 1, wherein the at least one user device includes a plurality of smart devices and/or at least one smart device and at least one set-top box.

3. The method of claim 1, comprising receiving the request from a respective set-top box, a respective smart device, or via a customer care representative.

4. The method of claim 1, further comprising:
determining whether the user is authorized to purchase the subscription or purchase of the program prior to prior to calculating the at least one entitlement.

5. The method of claim 1, wherein calculating the at least one entitlement comprises:
identifying codes corresponding to the subscription or purchase; and
identifying respective channels in the subscription or a channel on which the purchased program is provided based, at least in part, on a mapping of codes to channels for a geographic location of the user.

6. The method of claim 1, further comprising:
receiving a confirmation message confirming receipt of the at least one pushed entitlement by each at least one user device, by the processing device; and
if the confirmation message is not received, periodically pushing the at least one entitlement to the at least one user device until the confirmation message is received or up to a predetermined number of times.

7. The method of claim 1, wherein pushing at least one entitlement comprises:
pushing at least one instruction to each at least one user device to update a user interface displayable by the user device to reflect that the user is entitled to a respective channel and/or program.

8. The method of claim 7, wherein the at least one instruction comprises an instruction to remove an icon associated with the respective channel and/or program indicative of the respective channel and/or program being prevented from viewing by the user.

9. The method of claim 1, wherein program content is provided to each at least one user device in a scrambled format, the method further comprising:
pushing at least one key to each at least one user device to descramble received program content in the subscription or to descramble the program.

10. The method of claim 1, comprising:
receiving the request from a set-top box and pushing the at least one entitlement to all set-top boxes of the user and to all smart devices of the user; or
receiving the request from a smart device and pushing the entitlements to all set-top boxes of the user and to all smart devices of the user; or
receiving the request via a customer service representative and pushing the at least one entitlement to all set-top boxes of the user and/or to all smart devices of the user.

11. A system for managing entitlements to content of a content delivery system, comprising:
at least one database for storing:
mappings between video packages provided by the content delivery system and respective channels for receiving the programs in the video packages in respective geographic locations;
mappings between individual programs and respective channels for receiving the individual programs in respective geographic locations; and
connection information for user devices of respective users; and
a processing device configured to:
receive a request, from a user, to subscribe to a video package or to purchase a program from the content delivery system, the user having at least one user device configured for watching the programs;
calculate at least one entitlement by determining one or more channels associated with the subscribed to video package or purchased program in a geographic location of the user, respectively, based, at least in part, on the mappings in the at least one database;
obtain connection information for each at least one user device from the at least one database; and
push the at least one entitlement to each at least one user device, via a network, using the connection information.

12. The system of claim 11, wherein the mappings include billing codes correlated with respective video packages or the individual programs and one or more respective channels, the at least one processing device being further configured to:
identify at least one billing code associated with the subscribed to video package or purchased program, based on the mappings; and
determine one or more channels associated with the subscribed to video package or purchased program, respectively, based on the at least one identified billing code.

13. The system of claim 11, wherein the at least one processing device is further configured to:
determine the one or more channels by a billing system comprising a billing system application and a database; and
identify the respective channels under the control of an entitlement application based on the at least one billing code; and
push the at least one entitlement under the control of a push notification application.

14. The system of claim 13 wherein:
the at least one processing device is a cloud-based virtual processing device;
the entitlement application comprises a first web-based cloud-application; and
the push notification service application comprises a second web-based cloud application.

15. The system of claim 11, wherein the at least one user device includes a plurality of smart devices and/or at least one smart device and at least one set-top box.

16. The system of claim 11, wherein the processing device is configured to receive the request from a respective set-top box, a respective smart device, or from a user via a customer care representative.

17. The system of claim 11, wherein the at least one processing device is configured to:
receive a confirmation message confirming receipt of the at least one pushed entitlement by each at least one user device; and
if the confirmation message is not received, store the at least one pushed entitlement by each user device in the at least one database:
periodically retrieve the stored at least one pushed entitlement; and
push the at least one retrieved entitlement until the confirmation message is received or up to a predetermined number of times.

18. The system of claim 11, wherein the at least one processing device is configured to push the at least one entitlement by:
pushing at least one instruction to each at least one user device to update a user interface displayable by the user device to reflect that the user is entitled to view a respective channel and/or program.

19. The system of claim 11, wherein the at least one processing device is configured to:
provide program content to each user device in a scrambled format; and
send at least one key to each at least one user device to descramble program content available in the subscription or to descramble the program.

20. A video streaming device comprising:
storage for storing a video streaming platform client and a graphical user interface including an electronic program guide; and
a processing device configured to:
receive entitlements pushed by a content delivery system while active, via a network;
update the graphical user interface to indicate that a user is entitled to view respective channels and/or programs, based, at least in part, on the received entitlement; and
display the updated graphical user interface.

21. The video streaming device of claim 20, wherein the processing device is configured to update the graphical user interface by removing an icon associated with the respective channel and/or program indicative of the respective channel and/or program being prevented from viewing by the user.

22. The video streaming device of claim 20, comprising a set-top box or a smart device.

23. The video streaming device of claim 20, wherein the at least one processing device is configured to:
receive program content from the content delivery system; and
cause display of the received program content that the user has received an entitlement to, on a display device associated with the video streaming device.

24. The video streaming device of claim 23, wherein the received program content is scrambled and the processing device is configured to:
receive at least one key for descrambling scrambled program content from the content delivery system, via a network;
descramble the scrambled program content using the at least one key; and
cause display of the descrambled program content.
